(19) United States
(12) Patent Application Publication
(10) Pub. No.: US 2008/0130303 A1
(43) Pub. Date: Jun. 5, 2008

(54) LIGHT EMITTING DIODE STOP/TAIL/TURN LIGHT ASSEMBLY AND METHOD OF OPERATION

(75) Inventors: Michael Medina, Brookfield, WI (US); Steven Osgood, Campbellsport, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/566,737

(22) Filed: Dec. 5, 2006

(51) Int. Cl. B62J 6/04

(52) U.S. Cl. 362/475; 362/473

(57) ABSTRACT

A tail light assembly for a motorcycle. The tail light assembly includes a housing configured to receive a circuit. The circuit includes a light emitting diode (LED) and a controller. The LED provides tail, stop, and turn visual indications associated with the motorcycle. The controller supplies a voltage to the LED to light the LED to a brightness based on the signals received. In addition, the controller also sinks a current of a magnitude substantially equivalent to a magnitude of current drawn by an incandescent lamp when providing a visual turn indication.

### BACKGROUND

Motorcycles often include several sets of lights which serve to make a motorcycle more visible to other drivers, as well as to signal the intention of the motorcycle's rider (e.g., via turn signals). Often, lights are mounted near the front of a motorcycle so that they are visible to motorists and others in front of the motorcycle. In addition, lights are often mounted near the rear of a motorcycle so that the motorcycle's rider is clearly visible from behind.

Motorcycles generally include a headlight and left and right turn signal lights mounted near the front. Motorcycles also generally include a tail/stop light, and left and right turn signal lights near the rear. The lights generally include an incandescent bulb and can be controlled by an electronic control module.

### SUMMARY

In one embodiment, the invention provides a tail light assembly for a motorcycle. The tail light assembly includes a circuit and a housing configured to receive the circuit. The circuit includes a first light emitting diode (“LED”) configured to provide at least a visual turn indication associated with the motorcycle, and a controller having at least one controller input and at least one controller output. The at least one controller output is configured to supply current to the first LED. The tail light assembly is configured to draw current having at least a first current magnitude when an input signal corresponding to the visual turn indication is received by the controller, wherein the first current magnitude is substantially equivalent to a magnitude of current drawn by a second tail light assembly employing an incandescent lamp to provide a visual turn indication.

In another embodiment, the invention provides a method of operating a tail light assembly including a first LED, a controller having at least one controller input and at least one controller output, and a housing. The method comprises receiving an input signal corresponding to a visual turn indication on the at least one controller input, supplying a current to the LED from the at least one controller output, providing the visual turn indication, and drawing, by the tail light assembly, a current having a first current magnitude, the first current magnitude substantially equivalent to a magnitude of current drawn by a second tail light assembly employing an incandescent lamp to provide the visual turn indication.

In another embodiment, the invention provides a motorcycle including an engine, a plurality of wheels, and a lighting and indication system. The lighting and indication system includes at least one headlight, a plurality of forward turn signals, and a plurality of tail light assemblies. Each of the tail light assemblies includes a circuit having a first LED configured to provide at least a visual turn indication associated with the motorcycle, and a controller having at least one controller input and at least one controller output, the at least one controller output configured to supply current to the first LED. Each of the tail light assemblies also includes a housing configured to receive the circuit. Each of the tail light assemblies is configured to draw current having at least a first current magnitude when an input signal corresponding to the visual turn indication is received by its respective controller. The first current magnitude is substantially equivalent to a magnitude of current drawn by a second tail light assembly employing an incandescent lamp to provide a visual turn indication.

Other aspects of the invention will become apparent by consideration of the detailed description and accompanying drawings.

### BRIEF DESCRIPTION OF THE DRAWINGS

FIG. 1 illustrates a perspective view of a motorcycle according to an embodiment of the invention.

FIG. 2 illustrates a rear view of a motorcycle according to an embodiment of the invention.

FIG. 3 illustrates a top view of a motorcycle according to an embodiment of the invention.

FIG. 4 illustrates a schematic diagram of an embodiment of a lighting system according to an embodiment of the invention.

FIG. 5 illustrates a schematic diagram of a plurality of switches and inputs to an electronic control module of the lighting system of FIG. 4.

FIG. 6A illustrates a front view of a tail/stop/turn light according to an embodiment of the invention.

FIG. 6B illustrates a side view of a tail/stop/turn light according to an embodiment of the invention.

FIG. 6C illustrates a top view of a tail/stop/turn light according to an embodiment of the invention.

FIG. 7 illustrates an exploded view of the tail/stop/turn light of FIGS. 6A-6C according to an embodiment of the invention.

FIG. 8 illustrates a circuit for a tail/stop/turn light according to an embodiment of the invention.

FIG. 9 is a flow chart of an operational process of the tail/stop/turn light of FIG. 8 according to an embodiment of the invention.

FIG. 10 illustrates a circuit diagram for a turn signal circuit employing an LED and an incandescent light according to an embodiment of the invention.

FIG. 11 illustrates a circuit diagram for a turn signal circuit employing an LED and a current sinking resistor to mimic the current draw of an incandescent light according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

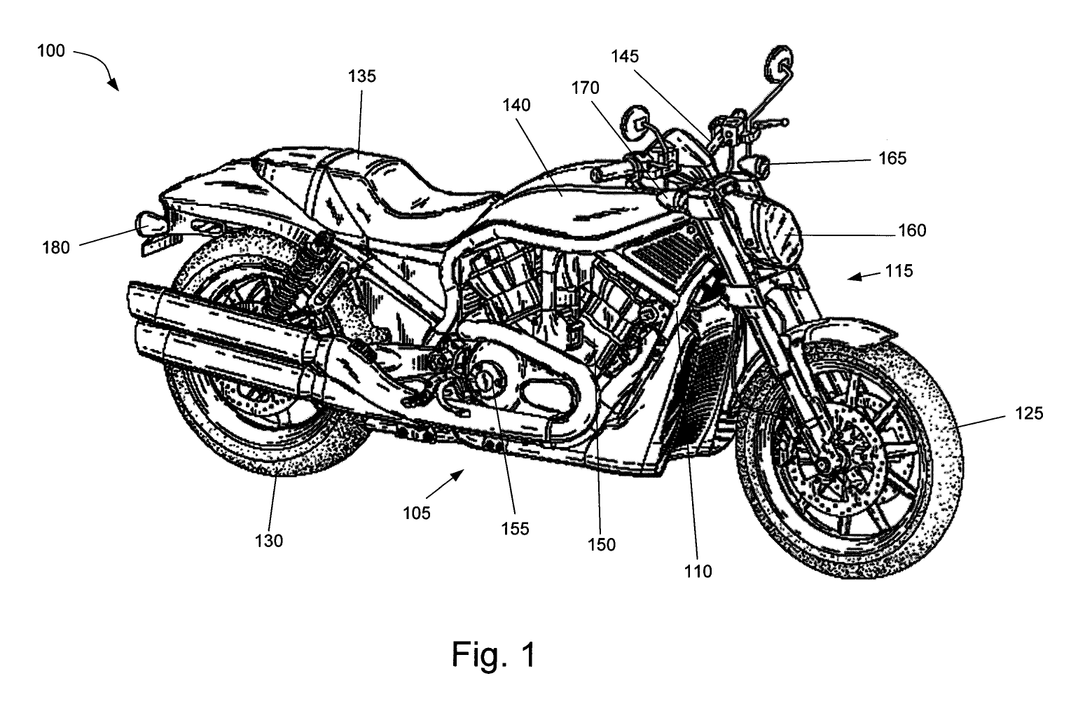

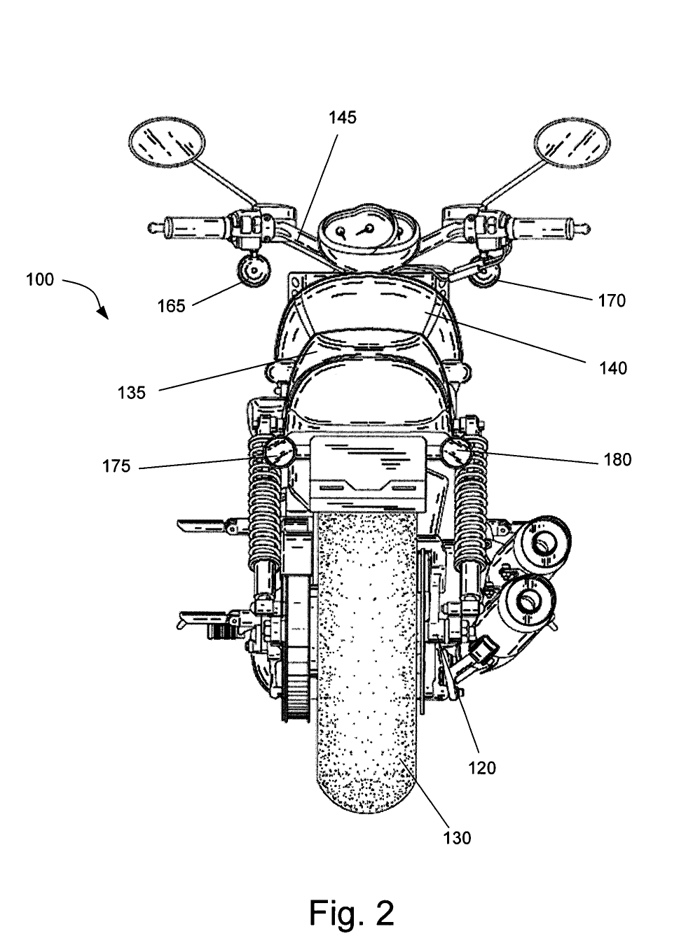

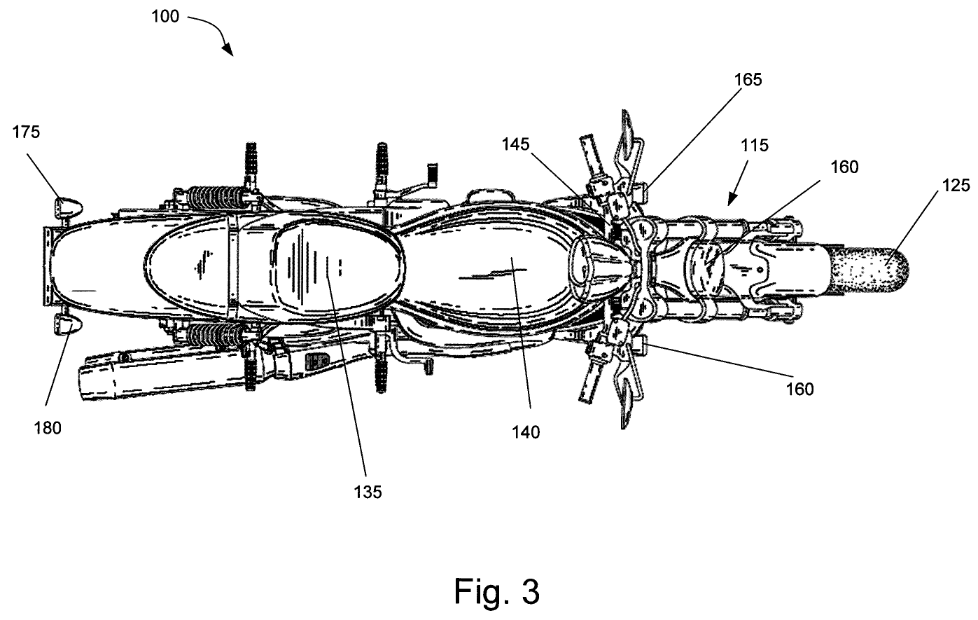

FIGS. 1-3 illustrate perspective, rear, and top views of an exemplary motorcycle 100. The motorcycle 100 includes a drive assembly 105, a frame 110, a front fork assembly 115, a swing arm or rear fork assembly 120, a front wheel 125, a rear wheel 130, a seat 135, and a fuel tank 140. The frame 110 supports the drive assembly 105, the front fork assembly 115, the rear fork assembly 120, the seat 135, and the fuel tank 140. The front fork assembly 115 is pivotally supported at a front end of the motorcycle 100 and supports the front wheel 125. The front fork assembly 115 includes a pair of handlebars 145 for steering the motorcycle 100. The rear fork assembly 130 is coupled to the frame 110 at a rear end of the motorcycle 100 and rotatably supports the rear wheel 130. The seat 135 is coupled to the frame 110 and is configured for supporting a rider. The fuel tank 140 is supported by the frame 110 and provides fuel to the drive assembly 105.

The drive assembly 105 includes an engine 150 and a transmission 155. The engine 150 and the transmission 155 comprise distinct, independent components of the drive assembly 105. The engine 150 includes an output shaft (not shown), such as a crankshaft, which includes a primary drive sprocket (not shown) for driving a primary chain (not shown) in a conventional manner to power the transmission 155.

The motorcycle 100 also includes a headlight 160, a front left turn signal 165, a front right turn signal 170, a rear left tail/stop/turn light 175, and a rear right tail/stop/turn light 180.

A conventional lighting system for a motorcycle includes a headlight, a front right turn light, a front left turn light, a tail/stop light, and separate left and right rear turn lights. The lighting system of an embodiment of the invention combines the tail/stop light with the rear turn lights, resulting in a right and left tail/stop/turn light assembly.

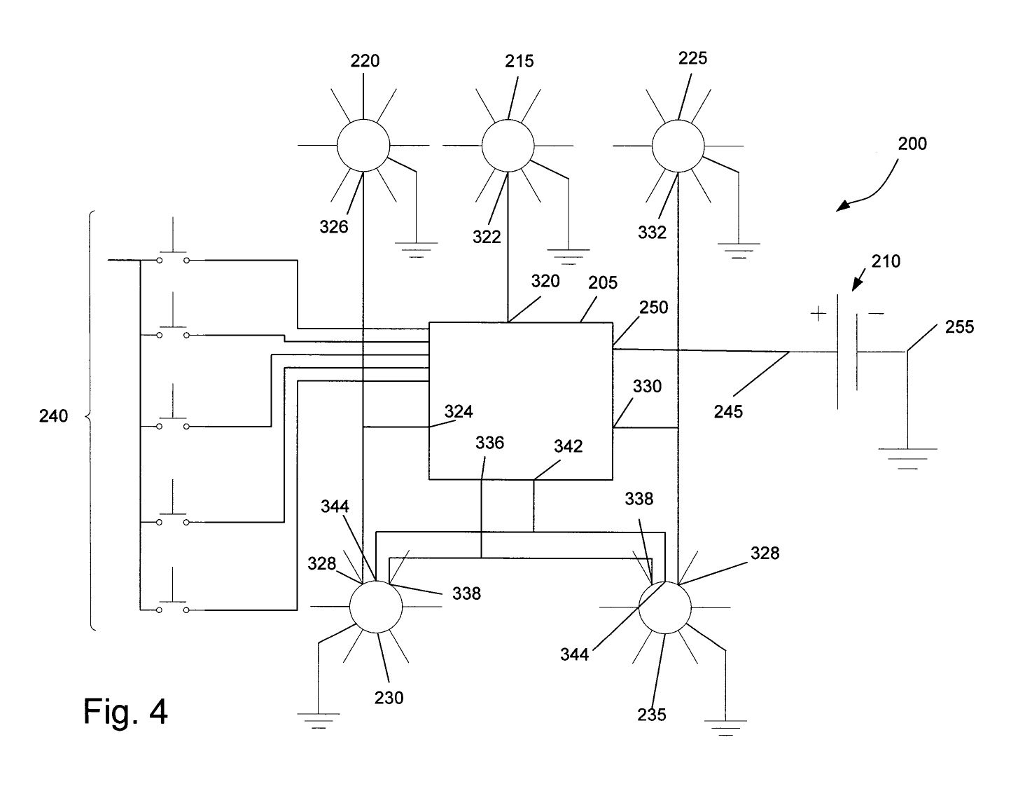

FIG. 4 illustrates a schematic diagram of an embodiment of a lighting and indication system 200 for a motorcycle. The lighting system 200 includes an electronic control module (“ECM”) 205, a battery 210 (e.g., 12 vdc), a headlight 215, a front left turn light 220, a front right turn light 225, a left tail/stop/turn light 230, a right tail/stop/turn light 235, and a plurality of switches 240.

The battery 210 has a positive terminal 245 connected to a power input 250 of the ECM 205 and a negative terminal 255 connected to a ground on the motorcycle.

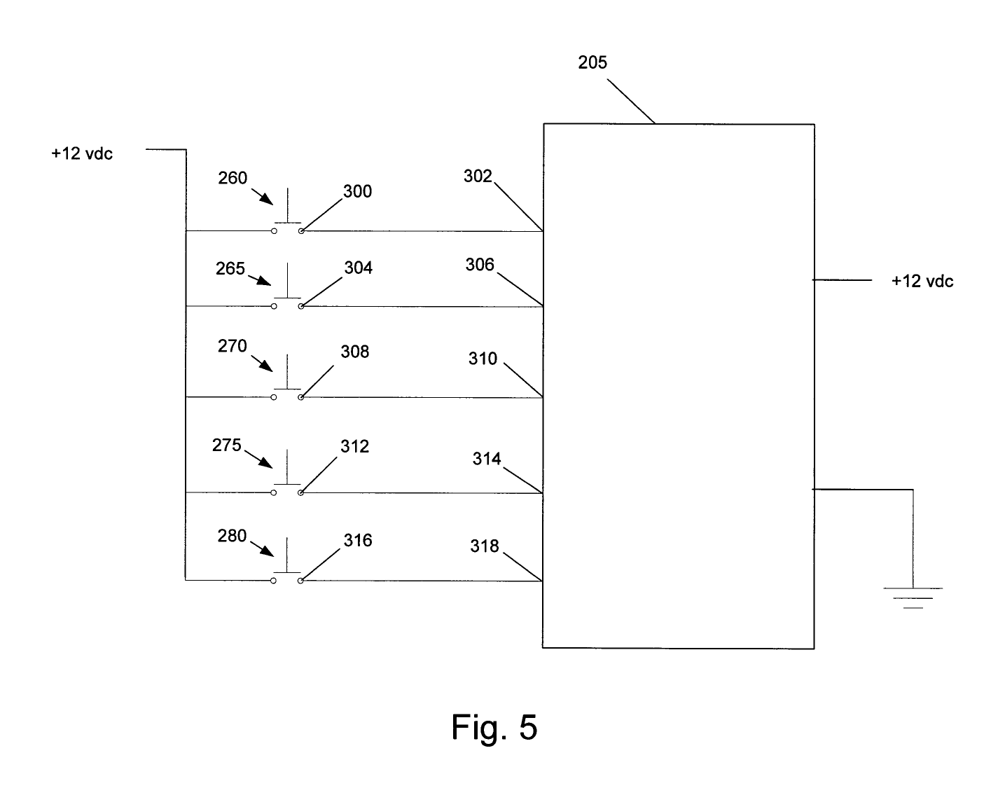

FIG. 5 illustrates the connections of the plurality of switches 240 to the ECM 205 for the embodiment shown. The plurality of switches 240 include a front brake switch 260, a rear brake switch 265, an ignition switch 270, a right turn switch 275, and a left turn switch 280. A first terminal of each of the plurality of switches 240 is connected to a power signal (e.g., +12 vdc from the positive terminal 245 of the battery 210). A second terminal of each of the plurality of switches 240 is connected to a separate input of the ECM 205. In particular, a front brake switch second terminal 300 is connected to a first brake input 302 of the ECM 205. A rear brake switch second terminal 304 is connected to a second brake input 306 of the ECM 205. In some embodiments, the first and second brake inputs 302 and 306 of the ECM 205 can be the same input. An ignition switch second terminal 308 is connected to an ignition input 310 of the ECM 205. A right turn switch second terminal 312 is connected to a right turn input 314 of the ECM 205. A left turn switch second terminal 316 is connected to a left turn input 318 of the ECM 205.

Referring back to FIG. 4, a headlight output 320 of the ECM 205 is connected to an input 322 of the headlight 215. A left turn output 324 of the ECM 205 is connected to an input 326 of the front left turn light 220 and a turn input 328 of the left tail/stop/turn light 230. A right turn output 330 of the ECM 205 is connected to an input 332 of the front right turn light 225 and a turn input 328 of the right tail/stop/turn light 235. A tail output 336 of the ECM 205 is connected to a tail input 338 of the left tail/stop/turn light 230 and a tail input 338 of the right tail/stop/turn light 235. A stop output 342 of the ECM 205 is connected to a stop input 344 of the left and right tail/stop/turn lights 230 and 235.

When the ignition switch 270 closes (e.g., when a rider starts an engine), a signal (e.g., +12 vdc) is provided to the ignition input 310 of the ECM 205. The ECM 205 detects the signal on its ignition input 310 and provides a signal (e.g., +12 vdc) to its headlight output 320, thereby applying the signal to the input 322 of the headlight 215. The ECM 205 also provides a signal (e.g., +12 vdc) to its tail output 336, thereby applying the signal to the tail input 338 of the left tail/stop/turn light 230 and the right tail/stop/turn light 235.

When the front brake switch 260 closes (e.g., when a handlebar brake is engaged by a rider), a signal (e.g., +12 vdc) is provided to the first brake input 302 of the ECM 205. The ECM 205 detects the signal on its first brake input 302 and provides a signal (e.g., +12 vdc) to its stop output 342, thereby applying the signal to the stop input 344 of the left tail/stop/turn light 230 and the right tail/stop/turn light 235.

When the rear brake switch 265 closes (e.g., when a foot brake is engaged by a rider), a signal (e.g., +12 vdc) is provided to the second brake input 306 of the ECM 205. The ECM 205 detects the signal on its second brake input 306 and provides a signal (e.g., +12 vdc) to its stop output 342, thereby applying the signal to the stop input 344 of the left tail/stop/turn light 230 and the right tail/stop/turn light 235.

When the right turn switch 275 closes (e.g., when a rider engages the right turn switch 275), a signal (e.g., +12 vdc) is provided to the right turn input 314 of the ECM 205. The ECM 205 detects the signal on its right turn input 314 and provides a signal (e.g., +12 vdc) to its right turn output 330, thereby applying the signal to the input 332 of the front right turn light 225 and the turn input 328 of the right tail/stop/turn light 235.

When the left turn switch 280 closes (e.g., when a rider engages the left turn switch 280), a signal (e.g., +12 vdc) is provided to the left turn input 318 of the ECM 205. The ECM 205 detects the signal on its left turn input 318 and provides a signal (e.g., +12 vdc) to its left turn output 324, thereby applying the signal to the input 326 of the front left turn light 220 and the turn input 328 of the left tail/stop/turn light 230.

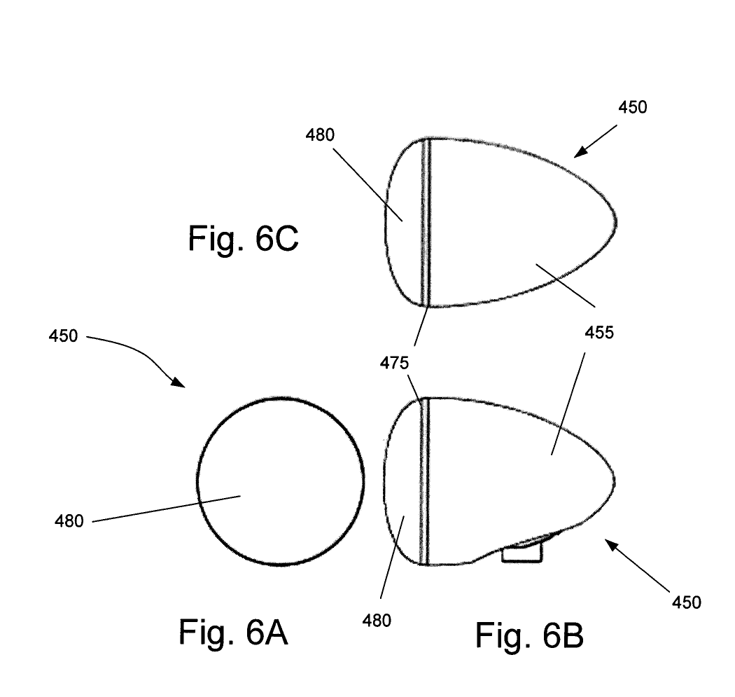

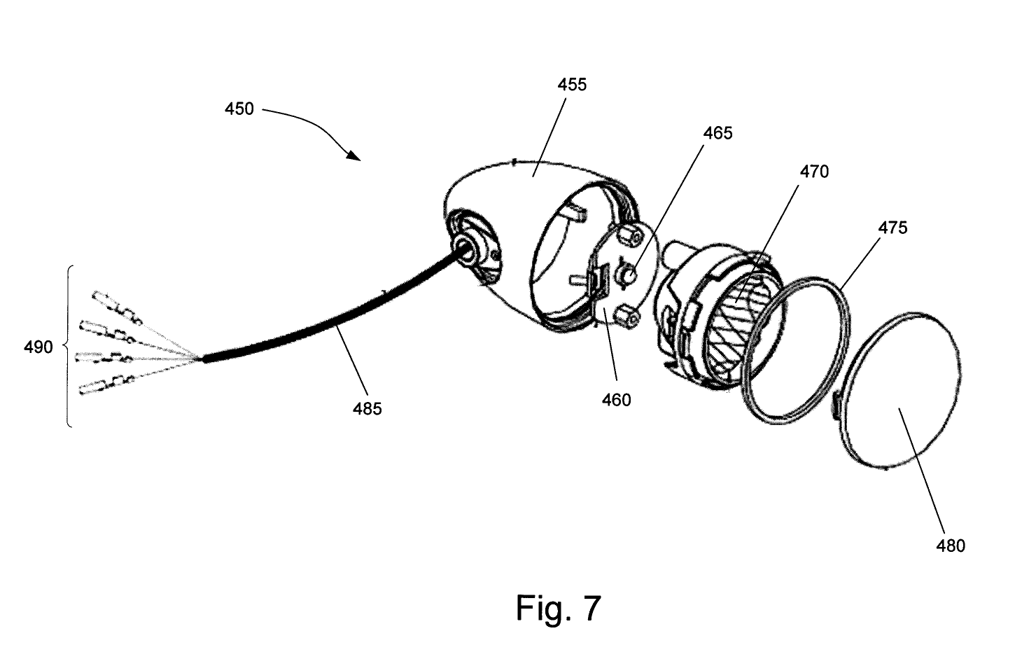

FIGS. 6A-6C illustrate front, side, and top views, respectively, of an embodiment of a tail/stop/turn light assembly 450. FIG. 7 is an exploded view of an embodiment of the tail/stop/turn light assembly 450. The tail/stop/turn light assembly 450 includes a housing 455, a circuit board 460, an LED 465, a reflector 470, a seal 475, and a lens 480. In some embodiments, the housing 455 has a generally rounded conical (i.e., bullet) shape. The housing 455 is configured to receive and mount the circuit board 460, the reflector 470, the seal 475, and the lens 480. The shape of the housing 455 can enable the tail/stop/turn light assembly 450 to have relatively low wind resistance when mounted on a motorcycle. The housing 455 can be constructed of any suitable material including injection molded plastic and chromed steel. In some embodiments, the lens 480 is about 2.38 inches in diameter and the combined length of the housing 455 and lens 480 is about 3.28 inches.

In the illustrated embodiment, the lens 480 is formed by injection molding a translucent thermoplastic (e.g., polyethylene) such that light is allowed to pass through the lens 480. The lens 480 can be any color. However, to meet regulations applicable to a motorcycle tail/stop/turn light assembly (e.g., Federal Motor Vehicle Safety Standard 571.108), the lens 480 is either red (for use with any color LED 465, e.g., white) or clear for use with a red LED 465. The lens 480 can include external threads for screwing onto internal threads in the housing 455.

The seal 475 can be positioned between the housing 455 and the lens 480. When the lens 480 is screwed into the housing 455, the seal 475 can form a water-tight seal and prevent water and other debris from entering the housing 455.

The reflector 470 includes a plurality of multifaceted reflecting surfaces designed to reflect and evenly distribute light from the LED 465 out through the lens 480.

A cable 485 including a plurality of wires 490 (e.g., four) links the tail/stop/turn light assembly 450 to an ECM on a motorcycle.

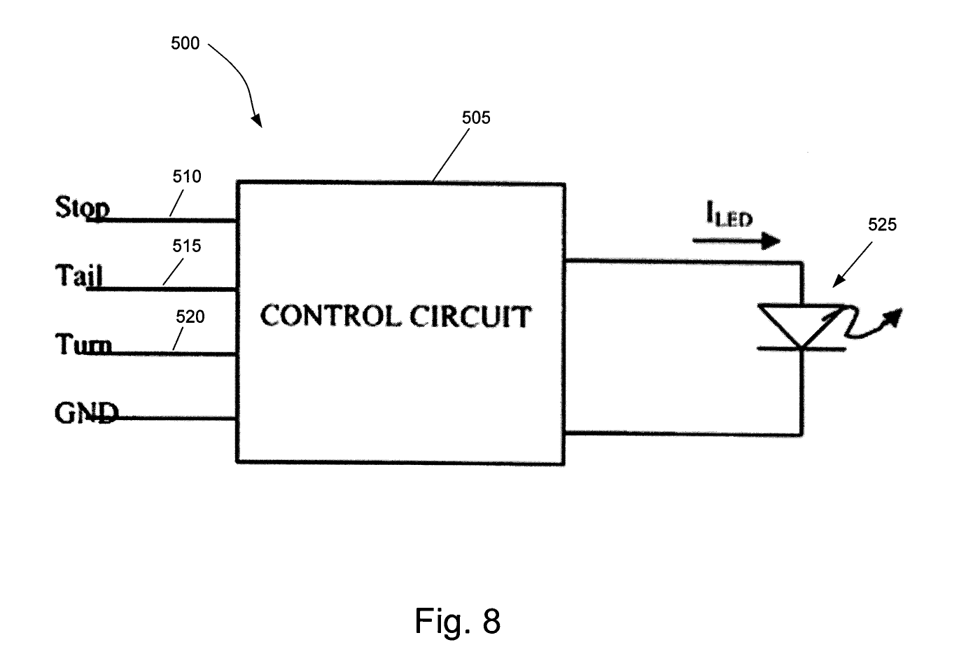

FIG. 8 illustrates a block diagram of a tail/stop/turn light 500 according to an embodiment of the invention. A control circuit 505 receives three input signals: a stop input 510, a tail input 515, and a turn input 520. The control circuit 505 also has a connection to ground. The control circuit 505 drives the LED 525 based on the combination of signals received on the three inputs—stop 510, tail 515, and turn 520.

The control circuit 505 can provide a first current (e.g., 0.02 amps) to the LED 525 to light the LED 525 at a first brightness. The control circuit 505 can also provide a second current (e.g., 0.2 amps) to light the LED 525 at a second brightness that is substantially brighter than the first brightness.

In some embodiments, the control circuit 505 can provide additional currents to the LED 525 to produce additional brightness levels (e.g., to provide one brightness for daytime operation and another brightness for nighttime operation).

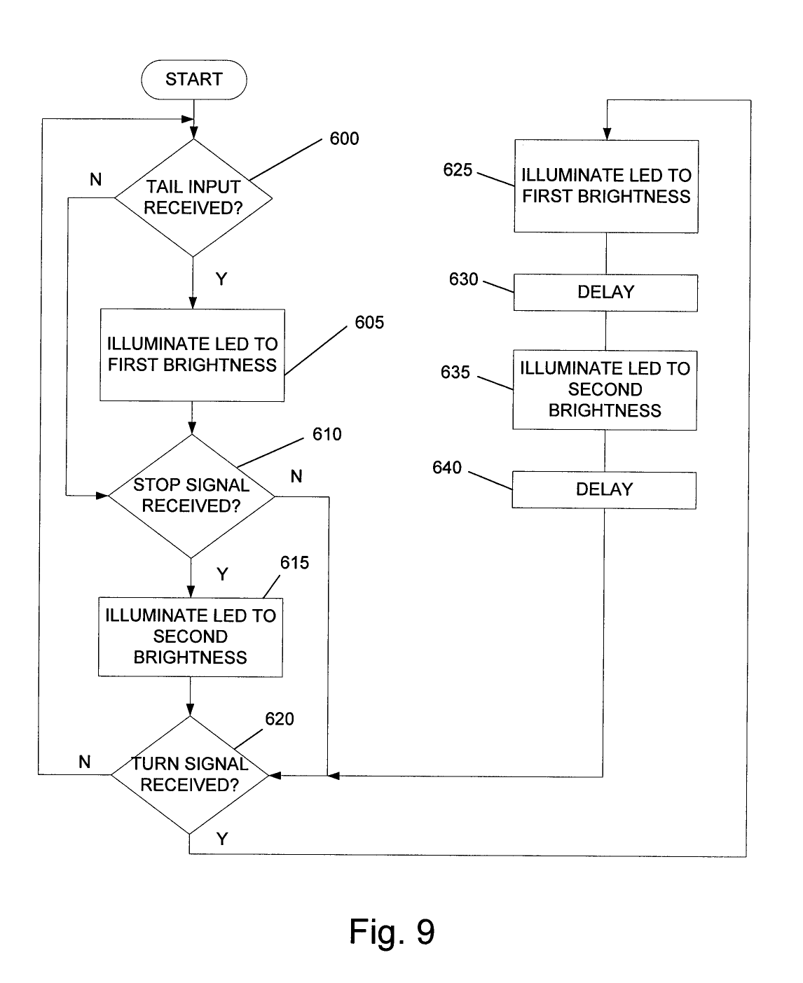

FIG. 9 illustrates a flow chart of an operational process of the tail/stop/turn light 500 of FIG. 8 according to an embodiment of the invention. The control circuit 505 of the tail/stop/turn light 500 determines, at block 600, whether the control circuit 505 is receiving a signal on its tail input 515. The ECM provides the tail/stop/turn light 500 with a signal at the tail input 515 whenever the ignition switch of the motorcycle is turned on. If a signal is received at the tail input 515, the tail/stop/turn light 500 illuminates the LED 525 to the first brightness (block 605). If a signal is not received on the tail input 515, the control circuit 505 skips block 605.

Next, the control circuit 505 determines, at block 610, whether it is receiving a signal on its stop input 510. The ECM provides the tail/stop/turn light 500 with a signal at the stop input 510 whenever the front or rear brake switch of the motorcycle is closed. If a signal is received at the stop input 510, the tail/stop/turn light 500 illuminates the LED 525 to the second brightness (block 615). If a signal is not received on the stop input 510, the control circuit 505 skips block 615.

Next, the control circuit 505 determines, at block 620, whether it is receiving a signal on its turn input 520. If a signal is not received on the turn input 520, the control circuit 505 loops back to block 600. If a signal is received on the turn input 520, the control circuit 505 illuminates the LED 525 to the first brightness (block 625). The control circuit 505 then delays for a period of time (e.g., 0.5 seconds) (block 630) and then illuminates the LED 525 to the second brightness (block 635). The control circuit 505 then delays for a second time period (block 640) and continues at block 620 to check if a signal is received on the turn input 520. In some embodiments, the first and second time periods are substantially equal.

FIG. 10 illustrates an embodiment of a circuit 650 for a front and back turn signal. An ECM 655 is connected to +12 vdc (e.g., the battery 210) and ground. A turn switch 660 is connected to +12 vdc on its first terminal and is connected to a turn input 665 of the ECM 655. A turn output 670 of the ECM 655 is connected to a front turn light 675 and a rear turn light 680 which are both also connected to ground. The front turn light 675 is an incandescent lamp and the rear turn light 680 is an LED. A typical incandescent lamp draws about 2 amps when provided with a 12 vdc signal. An LED, however, draws substantially less current than the incandescent lamp (e.g., 0.2 amps). Therefore, the total circuit 650 draws about 2.2 amps when the switch 660 is closed. An ECM designed to monitor current in a turn signal circuit using incandescent lights for both the front and rear turn signals expects the circuit to draw approximately 4 amps (2 amps for the front turn light plus 2 amps for the rear turn light). Since the circuit of FIG. 10 draws only 2.2 amps, a standard ECM would determine that one of the lights is burned out and provide an indication to the operator that a light is burned out even though both lights are functioning properly.

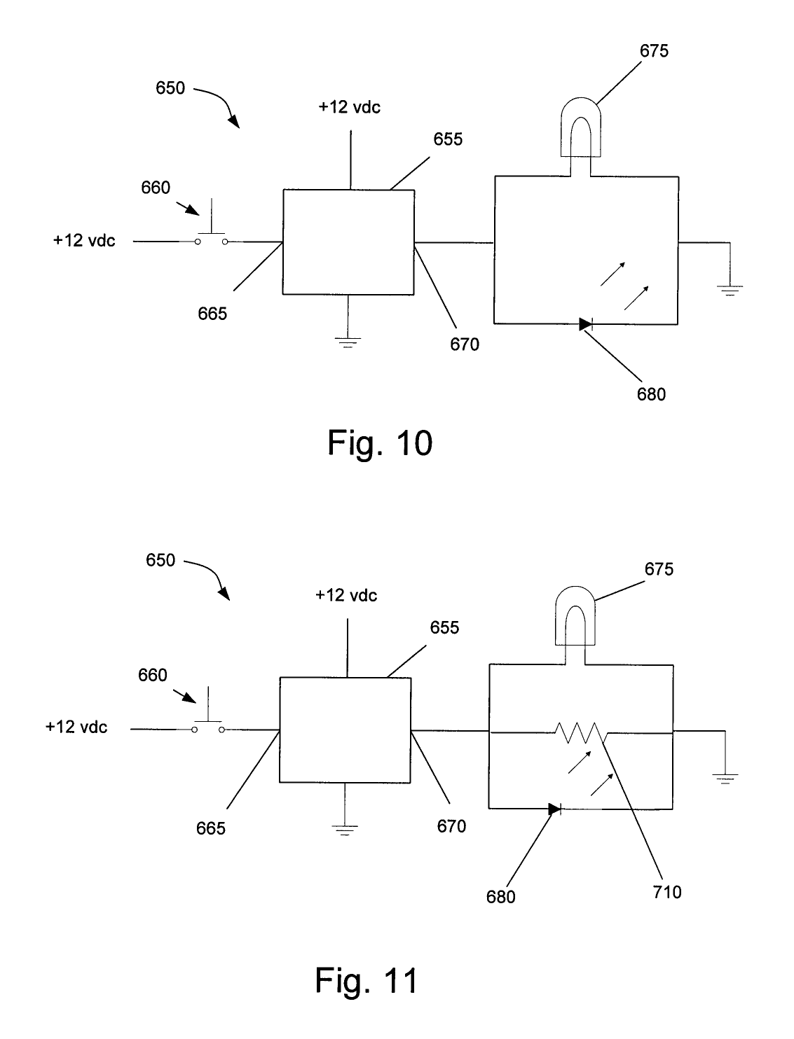

FIG. 11 illustrates the turn signal circuit 650 of FIG. 10 configured to draw enough current such that an ECM does not falsely detect a burned out lamp. A power resistor 710 is provided in parallel with the front turn light 675 (i.e., incandescent light) and the rear turn light 680 (i.e., LED). When switch 660 is closed, the resistance of the incandescent lamp, the LED, and the power resistor 710 combine to approximate the resistance of two incandescent lamps and to draw about 4 amps. In some embodiments, the power resistor can use a housing of a tail/stop/turn light as a heat sink.

In some embodiments of an LED tail/stop/turn light assembly, the control circuit 505 (FIG. 8) receives the stop 510, tail 515, and turn 520 input signals from the ECM. The control circuit 505 illuminates the LED 525 to the first or second brightness as shown in Table 1 below. The control circuit 505 also sinks enough current such that the ECM does not falsely detect a burned out light.

When the motorcycle is turned off (i.e., the ignition switch is open), no signal is applied to the tail input of the control circuit 505. No voltage is available to the LED 525 and the LED 525 is off. When the motor is turned on (i.e., the ignition switch is closed), there is a signal at the tail input 515 of the control circuit 505. There are four possible combinations of the stop input 510 and the turn input 520 when the ignition is turned on. In the first scenario, there is no signal at either the stop input 510 or the turn input 520. The control circuit 505 drives the LED 525 with 0.02 amps, illuminating the LED 525 at a low brightness.

TABLE 1

| Controller Inputs | | | | | | |
|---|---|---|---|---|---|---|
| Tail | | | Voltage* | Current** | Power** | LED |
| (ignition) | Stop | Turn | (vdc) | (amps) | (watts) | Brightness |
| 0 | x | x | 0 | 0 | 0 | Off |
| 1 | 0 | 0 | 13.5 | 0.02 | 0.27 | Low |
| 1 | 1 | 0 | 13.5 | 0.2 | 2.7 | High |
| 1 | 0 | 1 | 13.5 | 1.55 | 21 | Cycle |
| 1 | 1 | 1 | 13.5 | 1.55 | 21 | Cycle |

*Provided by the ECM to the controller.
**Drawn from the ECM by the controller.

In the second scenario, a signal is applied to both the tail input 515 and the stop input 510, but there is no signal applied to the turn input 520. The control circuit 505 drives the LED 525 with 0.2 amps of current, illuminating the LED 525 with a high brightness.

In the third scenario, a signal is applied to both the tail input 515 and the turn input 520, but there is no signal applied to the stop input 510. The control circuit 505 cycles driving the LED 525 between the low and the high brightness to flash the LED 525. The control circuit 505 also draws 1.55 amps from the ECM to mimic the current draw of an incandescent light.

In the fourth scenario, a signal is applied to the tail input 515, the stop input 510, and the turn input 520. The control circuit 505 cycles driving the LED 525 between the low and the high brightness to flash the LED 525. The control circuit 505 also draws 1.55 amps from the ECM to mimic the current draw of an incandescent light.

It is to be appreciated that the values of the electrical characteristics, the circuit configurations, the logic levels, etc. described herein (e.g., in Table 1) are exemplary and could be modified for particular implementations.

In various embodiments herein, an LED tail/stop/turn light assembly mimics the operation of a tail/stop/turn light assembly employing an incandescent light or the operation of a standard tail/stop light assembly and a separate turn light assembly both employing incandescent lights. Embodiments herein can be retrofit onto an existing motorcycle or used on a new motorcycle, without making modifications to the existing onboard electrical system and components. For instance, an existing ECM can be used with the LED tail/stop/turn light assembly without modification. Since LEDs generally do not burn out, a standard ECM used with the LED tail/stop/turn light assembly for the rear lights can determine if a front turn incandescent light is burned out and can provide an indication of such component failure to a rider.

In some embodiments, a tail/stop/turn light assembly can use more than one LED. For example, an amber LED can be used as a turn indication and a red LED can be used for the tail and stop indications. Further, one red LED can be used for the tail indication and a different or multiple red LEDs can be used for the stop indication. In addition, LED turn light assemblies can be used for the front turn indicators.

Thus, the invention provides, among other things, an LED tail/stop/turn light that can be used with a standard ECM. Various features and advantages of the invention are set forth in the following claims.

What is claimed is:

1. A tail light assembly for a motorcycle, the tail light assembly comprising:
a circuit including
a light emitting diode (LED) configured to provide at least a visual turn indication associated with the motorcycle, and
a controller having at least one controller input and at least one controller output, the at least one controller output configured to supply current to the LED; and
a housing configured to receive the circuit,
wherein the tail light assembly is configured to draw current having at least a first current magnitude when an input signal corresponding to the visual turn indication is received by the controller, wherein the first current magnitude is substantially equivalent to a magnitude of current drawn by a second tail light assembly employing an incandescent lamp to provide a visual turn indication in place of the LED.

2. The tail light assembly of claim 1 wherein the at least one controller input is electrically connected to a control module external to the tail light assembly.

3. The tail light assembly of claim 1 wherein the LED is red.

4. The tail light assembly of claim 1 wherein the tail light assembly is configured to conform to Federal Motor Vehicle Safety Standard 571.108.

5. The tail light assembly of claim 1 wherein the circuit includes an element to dissipate current when the input signal is received.

6. The tail light assembly of claim 5 wherein the element is a power resistor.

7. The tail light assembly of claim 6 wherein the housing is configured as a heat sink for the power resistor.

8. The tail light assembly of claim 1 wherein the at least one controller input includes a tail input, a stop input, and a turn input.

9. The tail light assembly of claim 8 wherein the tail light assembly is configured to draw current having a second current magnitude when a second input signal corresponding to a visual tail indication is received by the controller.

10. The tail light assembly of claim 9 wherein the tail light assembly is configured to draw current having a third current magnitude when a third input signal corresponding to a visual stop indication is received by the controller.

11. The tail light assembly of claim 10 wherein the first current magnitude is substantially greater than the second current magnitude and the third current magnitude.

12. The tail light assembly of claim 10 further comprising a second LED configured to provide a visual turn indication when the input signal is received, wherein the LED is configured to provide a visual tail indication when the second input signal is received and the LED is configured to provide a visual stop indication when the third input signal is received.

13. The tail light assembly of claim 12 wherein the second LED is amber.

14. The tail light assembly of claim 10 wherein the controller is configured to drive the LED to display a visual tail indication when the controller receives a signal on the tail input only and to display a visual stop indication when the controller receives a signal on the stop input but not on the turn input, the visual tail indication having a first brightness and the visual stop indication having a second brightness.

15. The tail light assembly of claim 14 wherein the second brightness is substantially brighter than the first brightness.

16. The tail light assembly of claim 15 wherein the controller is configured to drive the LED such that the LED oscillates between the first brightness and the second brightness when the controller receives a signal on the turn input.

17. A method of operating a motorcycle tail light assembly including a light emitting diode (LED), a controller having at least one controller input and at least one controller output, and a housing, the method comprising:
receiving an input signal corresponding to a visual turn indication on the at least one controller input;
supplying a current to the LED from the at least one controller output;
providing the visual turn indication; and
drawing, by the tail light assembly, a current having a first current magnitude, the first current magnitude substantially equivalent to a magnitude of current drawn by a second tail light assembly employing an incandescent lamp to provide the visual turn indication in place of the LED.

18. The method of claim 17 and further comprising dissipating current in an element when the input signal is received.

19. A motorcycle comprising:
an engine;
a plurality of wheels; and
a lighting and indication system including
at least one headlight,
a plurality of forward turn signals, and
a plurality of tail light assemblies, each of the tail light assemblies including
a circuit including
a light emitting diode (LED) configured to provide at least a visual turn indication associated with the motorcycle, and
a controller having at least one controller input and at least one controller output, the at least one controller output configured to supply current to the LED; and
a housing configured to receive the circuit,
wherein each tail light assembly is configured to draw current having at least a first current magnitude when an input signal corresponding to the visual turn indication is received by the controller, wherein the first current magnitude is substantially equivalent to a magnitude of current drawn by a second tail light assembly employing an incandescent lamp to provide a visual turn indication in place of the LED.

20. The motorcycle of claim 19 and further comprising a control module electrically connected to the at least one controller input, the control module configured to output the at least one input signal.
